(19) United States
(12) Patent Application Publication
(10) Pub. No.: US 2014/0025604 A1
(43) Pub. Date: Jan. 23, 2014

(54) SYSTEM AND METHOD FOR MANAGING DERIVATIVE INSTRUMENTS

(71) Applicant: trueEX Group LLC, New York, NY (US)

(72) Inventors: Sunil Hirani, Greenwich, CT (US); James Miller, New York, NY (US); Arthur Korsun, Forest Hills, NY (US)

(21) Appl. No.: 13/938,879

(22) Filed: Jul. 10, 2013

Related U.S. Application Data
(60) Provisional application No. 61/669,887, filed on Jul. 10, 2012.
(60) Provisional application No. 61/728,960, filed on Nov. 21, 2012.
(60) Provisional application No. 61/825,432, filed on May 20, 2013.

(51) Int. Cl. G06Q 40/06

(52) U.S. Cl. CPC G06Q 40/06
USPC 705/36 R

(57) ABSTRACT

The present invention is a system and method for providing improved functionality for management of derivative instruments. The improved system includes functionality implementing a margin requirement determination function to allow optimization of a portfolio based on impacts to the collateral a user is required to provide for the positions in the swap portfolio.

### PRIORITY INFORMATION

The present application is a continuation-in-part application, and claims priority to U.S. Provisional Application Ser. No. 61/669,887, filed on Jul. 10, 2012, titled Margin Optimizer Concept, in the names of Sunil Hirani and James Miller, Ser. No. 61/687,088, filed on Apr. 17, 2012, titled Unwinds Concept, in the names of Sunil Hirani and James Miller, Ser. No. 13/864,988, filed on Apr. 17, 2013, titled System And Method For Managing Derivative Instruments, in the names of Sunil Hirani and James Miller, Ser. No. PCT/US13/36987, filed on Apr. 17, 2013, titled System And Method For Managing Derivative Instruments, in the names of Sunil Hirani and James Miller, Ser. No. 61/728,960, filed on Nov. 21, 2012, titled Margin Optimizers, in the names of Sunil Hirani, James Miller and Alex Francisci, and Ser. No. 61/825,432, filed on May 20, 2013, titled FCM Capital Optimization Strategy (COS™), in the names of Sunil Hirani and Arthur Korsun, the contents of each of which are incorporated herein in their entireties by reference thereto.

### BACKGROUND

The present invention relates to the management of derivative based financial instruments, commonly referred to as swaps, and more particularly to the optimization of portfolios of derivative instruments held by companies or traders when those instruments are transacted through a central clearing party.

### DEFINITIONS AND ACRONYMS

CCP—Central Counter-Party clearing house—An organization that helps facilitate trading in derivatives and equities markets. Clearing houses may be operated by major banks. The clearing house's prime responsibility is to provide efficiency and stability to the financial markets that they operate in.

There are two main processes that are carried out by CCPs: clearing and settlement of market transactions. Clearing relates to identifying the obligations of both parties on either side of a transaction. Settlement occurs when the final transfer of securities and funds occur.

CCPs benefit both parties in a transaction because they bear most of the credit risk. If two individuals deal with one another, the buyer bears the credit risk of the seller, and vice versa. When a CCP is used the credit risk that is held against both buyer and seller is coming from the CCP, which in all likelihood is much less than in the previous situation, and can be mitigated by pooling risk across a multiplicity of transactions.

CCP's mitigate the risk of a default by either party through a multiple stage defense, two levels of which frequently include imposition of margin requirements to a position, as well as enforced contributions to a guarantee fund as part of clearing a trade.

CMEEC—Chicago Mercantile Exchange European Clearing—A CCP clearing house associated with the Chicago Mercantile Exchange, operating in the London market.

FCM—Futures Commission Merchant—A Futures Commission Merchant is an entity involved in the solicitation or acceptance of orders for future delivery of obligations incurred as a result of a contract, such as an interest rate swap or other future delivery contracts. The FCM may assist transactions such as by providing credit to parties to a contract, as well as serving as a broker between the parties to a contract. FCM's may require collateral contributions to mitigate their risk, such as when the FCM provides a loan to cover margins required by a CCP.

LCH—London Clearing House—LCH.Clearnet, a London central clearing party.

Margin Requirements—Margin requirements are collateral requirements imposed by a central counterparty clearing house for undertaking the central role in a trade or swap. The margin requirements may be composed of an initial margin component, as well as a variation margin component. The initial margin component may be determined as a result of the particulars of the trade itself, i.e., the notional amount involved, the duration or tenor of the swap, risks associated with changing values of collateral provided to cover the margin requirement, as well as other factors decided upon by the CCP. The variation margin component may be determined as a function of subsequent market movements relating to positions and related collateral, such that a margin requirement for a held position can either increase or decrease.

Netting—Cross-reduction of payments resulting from an interest rate or other swap, i.e., where party A owes party B interest accrued on a fixed rate basis for a notional amount, party B contrarily owes party A a potentially different amount such as based on a variable rate for the same notional amount. Netting reduces the obligations of party A to pay party B by the amount of the obligation of party B to pay party A, and vice versa, such that only the amount above the lesser obligation is transferred. Netting may also occur where a party owns both positions, such that the extent of the obligation and the associated risk is reduced by netted amounts, such as when both positions are held through a single central counter party.

Novation—A procedure for a counterparty to transfer existing obligations of an interest rate swap to a new counterparty that enters the contract with the original remaining counterparty.

Interest rate swaps, such as simple swaps in which an offeror offers to swap the interest associated with a fixed rate for a notional amount for the interest associated with a variable rate on the same notional amount, or more complex transactions such as a swap involving a switch trade, which involves multiple swaps over different periods of time (referred to as the tenor of the swap) such as a 2×10 switch in which the offeror and an acquirer first implement a simple two year swap, followed by a 10 year swap with the roles reversed (i.e., the offeror first pays interest at a fixed rate, then changes roles and pays interest at a variable rate), allow financial entities to hedge risk associated with interest rates as they vary over time.

While the creation of derivative instruments is important to allow businesses to hedge risk, the ability of traders to optimize the holdings in a portfolio of derivative instruments is equally important. As markets and economies change, so does the optimal portfolio of derivative products for a company or trader, as the derivative instruments are frequently held as a hedge position, to reduce risk to the company or trader in the event of some market or economic change. The need to manage derivative instrument holdings can be brought about by a company or trader's underlying financial obligations no longer existing, such as when a bond or loan which had been hedged has been repaid or called, by a company or trader changing its position on forward rates, or by a company or trader changing its hedge strategy itself, such as by seeking to extend or reduce swap tenors.

Thus, companies and traders may need to adjust the derivative instruments on “positions” held in their portfolio of derivative instruments, such as reducing the number of instruments under which a fixed interest rate position has been taken counter to a variable interest rate position, or vice versa. While positions may be reversed by entering a new swap, a company or trader may equally prefer to allow another entity to step into the first company or traders position in a swap, thus relieving the first party of the financial obligations of the swap (as well as transferring financial benefits to the other party, referred to hereafter as the “step in party”).

When interest rate swaps are traded, the details of the trade (who traded, what type of instrument, quantity, price, etc.) are now required to be transacted through a central clearing house. The clearing house provides clearing services to the firms that submit the trade for clearing. Firms set up a clearing route to a clearing house so that they may use the clearing house's services. For a trade to be cleared through a particular clearing house, both firms who are party to the trade must have a clearing route established to the particular clearing house. The relationship to the clearing house may be through a relationship between a futures commission merchant, or directly from the derivative holder.

Thus, the clearing route may include the involvement of a futures commission merchant (“FCM”) which assists a party to a swap in entering that swap, such as by providing financing to a party or other services, as well as providing the relationship with the clearing house. Additionally, other financial entities may be involved in the path with respect to providing access to the funds or other assets of a party for use in conjunction with the initiation of a swap.

At present, the clearing of interest rate swaps takes place on two major clearinghouses: CME Group (formerly Chicago Mercantile Exchange and the Chicago Board of Trade) and The London Clearing House (LCH). Each of them has their strengths vis-à-vis the clearing of other correlated products that are separately being submitted to the each of the clearinghouses. CME typically currently clears EuroDolllar futures and LCH typically clears dealer to dealer swaps.

Firms that trade interest rate swaps may have clearing routes through either CME, or LCH, or both, as well as others as they may become available. Firms sometimes prefer to clear their trades through one clearing house or the other because they receive benefits such as lower margin rates or the preferences of their clients. However, firms may not always be able to clear through their preferred clearing house if both firms do not have clearing routes through the same clearing house. For example, in a trade between Firm A and Firm B, Firm A may have clearing routes through CME and LCH but prefer CME, while Firm B may only have a route through LCH. In this case Firm A would not be able to trade through their preferred clearing route.

One significant issue that must be considered with any consideration of portfolio management are margin requirements, which require holders to provide collateral to support any position. The collateral is typically used to back the reliability of performance of a position taken by a party to a swap, i.e., to ensure that funds are available to complete performance of a position. While central clearing parties undertake some risk in clearing a transaction, those same clearing parties mitigate their risk by requiring the parties to provide collateral to offset potential losses should one party or the other default on a transaction. This collateral is commonly referred to as a margin.

Margin requirements may be established by the CCP, as well as by FCM's involved in a transactional, based upon the relationship between the parties. Thus, the amount of collateral, i.e., “margin”, that a party must put up to implement a transaction is dependent upon the particular CCP's and FCM's involved in a transaction. The amount of collateral is not only relevant at the time a swap is entered into, but also whenever a swap position is managed, i.e., when any position is modified through a compaction, termination, or other management activity, as well as when variation margins are imposed by a central clearing party.

The amount of the collateral required is dependent on the potential financial exposure resultant from the swap. As risk may be undertaken by a central clearing party, that party typically imposes a requirement that a party to a swap provide the collateral such that their potential exposure is mitigated. Interest rate swaps involve the interest payable based on a notional amount over a specified term. Should one party to a swap default, the obligation to pay the agreed to interest to the contra party remains. Thus, the risk exposure is not the notional amount of the swap, but rather the potential exposure resultant from interest that may become due and payable as a result of the position.

The forms of the collateral which may be provided by a party to a swap include a wide range of financial vehicles, including legal currency, bonds, securities, and other financial instruments. Each of these instruments (including legal currencies) are subject to changes in value, such as through depreciation, inflation, maturing, change in value of an underlying asset, etc. Accordingly, determination of a sufficient margin by the CCP and/or FCM involves complex calculations to address not only potential exposure from a swap position, but also calculations involving potential variations in the value of the collateral provided for the margin, as well as off-setting of risk based on positions held by an owner of multiple derivative positions.

Parties to a swap typically desire to minimize the amount of collateral that must be provided, as providing the collateral as a margin for a swap reduces the ability of the party to use that collateral for other purposes, such as, for example, as a security interest for operating loans for ongoing operations.

Another major factor involved in determining the collateral amount is the existence of off-setting positions within a portfolio held by a party to a swap. A party to a swap may have positions which offset the risk of other positions, such that the potential risk of the combined positions is less than the potential risk of the sum of individual positions, i.e., allows for a reduced margin to be required. While such off-setting exists based on the positions themselves, holding positions at different CCP's and or FCM's may not result in reductions of the margin, as those individual CCP's and/or FCM's are basing their margin amount on the positions held by a party with that CCP and/or FCM. Thus, the margin requirement may be managed not only by selection of a particular CCP and/or FCM for initiating a swap, but also by controlling which CCP's and/or FCM's are utilized based on the existing portfolio positions of that party.

The quality and extent of positions with a particular CCP and/or FCM may result in additional discounts to the amount of margins required to be provided to a party. Accordingly, determination of a margin amount for a position or portfolio may not only vary between the path a transaction takes at initiation, but may also vary based on the CCP and/or FCM at which a portfolio is maintained.

In addition, several buy-side firms, because of their dominance and market power, may force their counterparties to clear in clearing houses where the counterparty does not have natural “offsets” and may face higher margin requirements. An individual firm, forced to trade through a clearing house which is not their preferred route, might want to move their trades from one clearing house to another in order to get the margin benefit of their preferred clearing house.

Users may alternately want to reduce the number of positions held in a portfolio, without changing the aggregate position in the portfolio. Such a desire may be accomplished by compacting the positions into a reduced number of or a single position, having a similar risk profile and obligations and benefits as the aggregated benefits and obligations of the non-compacted portfolio.

Under recent changes to requirements associated with derivative instruments, swaps are required to be cleared through a clearing house. While the regulations do not apply to pre-existing trades, benefits may accrue to the holder of those positions if the positions are cleared through a central counter party (“CCP”) clearing house. Accordingly, holders of portfolios may desire to have those pre-existing positions cleared through a CCP clearing house, referred to as back-loading.

The management of existing positions is dependent on valuing the present position, as well as connecting users and potential step-in parties, existing counterparties, and clearing houses and margin requirements to allow efficient management of an existing portfolio.

### SUMMARY OF THE INVENTION

The present application is a system and method for providing a derivative instrument management system that allows a user to efficiently and transparently adjust existing positions within a portfolio.

In a simple form, the system of the present invention is a computer-implemented derivative instrument management system comprising a computer platform having an interface that elicits and receives information from users of the system, an interface that allows communications with a clearing house for requesting clearing of management transactions associated with one or more positions associated with a user's portfolio, a database for storing information associated with a user's portfolio, and instructions for implementing a projected margin determination and displaying said projected margin to a user of the derivative investment management system.

Alternately, the present invention may be embodied in a computer implemented derivative instrument management process, comprising the steps of receiving at a derivative management platform a request from a user to determine a projected margin requirement associated with a proposed transaction, receiving from said user through a computer interface an identification of a position associated with said proposed transaction, generating a projected margin requirement for said transaction, and displaying said generated projected margin requirement for said transaction to said user.

### BRIEF DESCRIPTION OF THE FIGURES

FIG. 1 illustrates a simple process for incorporating consideration of a projected margin requirement determination within a swap transaction.

FIG. 2 illustrates simple interface for allowing a user of a DM platform to identify potential clearing routes for a user activity.

FIG. 3 illustrates a notional results screen for displaying projected margin requirement determinations to a user for a transaction based on potential clearing routes.

FIG. 4 illustrates a desired optimization transaction utilizing an indicative curve to identify a potential contra position to be used to optimize a position with respect to margin optimization.

FIG. 5 illustrates a notional contra party offering for inclusion in a single position optimization transaction.

FIG. 6 illustrates a remaining position after optimization of a position through implementation of a swap with respect to the contra offer shown in FIG. 5.

FIG. 7 illustrates a simple process for implementing projected margin generation with respect to the optimization shown in FIGS. 4-6.

FIG. 8 illustrates a simple process in which projected margin determination is utilized in portfolio optimization involving multiple positions held with multiple central clearing parties and in which consideration of multiple clearing routes is considered.

### DETAILED DESCRIPTION OF THE INVENTION

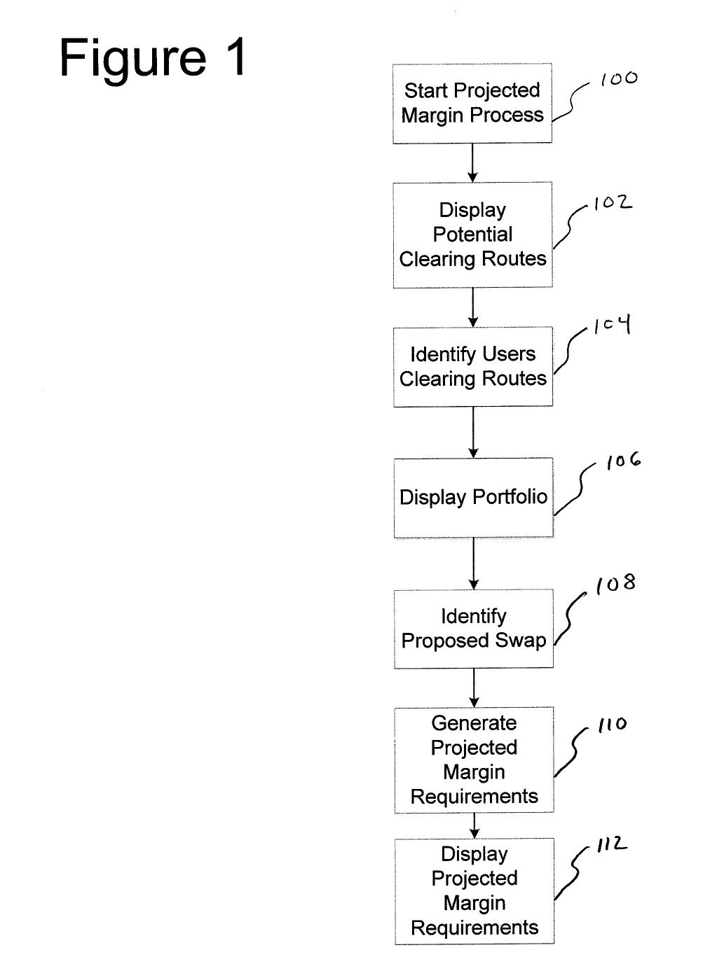

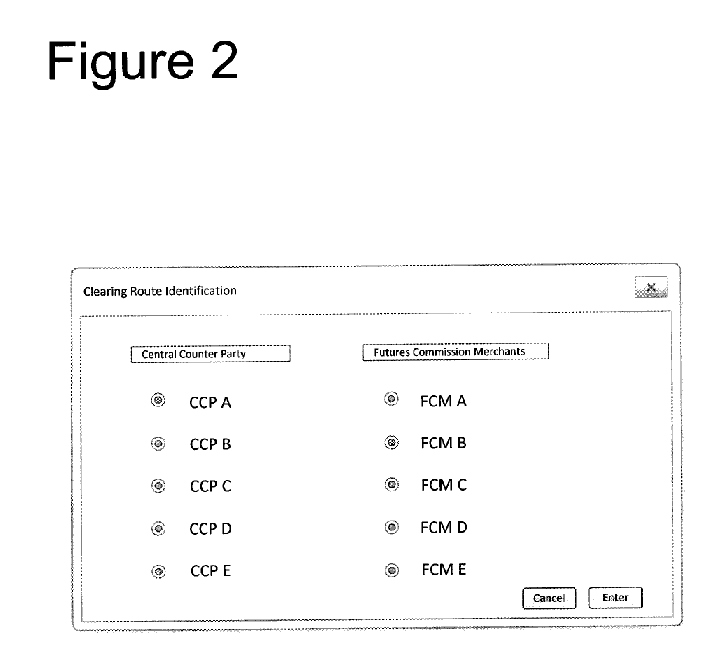

As shown in the Figures, in which like numerals are used to identify like elements, there is shown an embodiment of the present invention. In FIG. 1, there is shown a simplified process under which a user can evaluate entry into a swap position, with consideration limited to the initiation of a new swap, and no consideration of the effect of existing positions of the user held through one or more CCP's. The user may initiate 100 the process by clicking a button on a display grounded by DM platform. The DM platform may present 102 possible clearing routes to the user. Alternately or additionally, the user may identify 104 to the DM platform clearing routes desired to be considered. Information regarding potential clearing routes may be retrieved from a database identifying existing clearing routes for a user from prior transactions, from data previously provided by a user, or from data provided by the user at the time the user addresses a potential new transaction. The DM platform may then display 106 potential clearing routes for the transaction

Where a user does not have previously identified clearing routes, the DM platform may display possible 102 clearing routes, including CCP's and FCM's, such that the user can identify 104 potential parties to a clearing route for consideration. For example, as shown in FIG. 2, where five CCP's (202a, 202b, 202c, 202d, 202e) are available, and 5 FCM's (204a, 204b, 204c, 204d, 204e) are available, the DM platform may display 200 an image for the user, listing each of the CCP's and FCM's which are available, and allow the user to select CCP's and FCM's for consideration, such as by clicking a radio button 206 next to a CCP and/or FCM shown in the lists. In FIG. 2, CCP's A, C, and D are shown clicked, and FCM's C, D, and E are illustrated as having been selected.

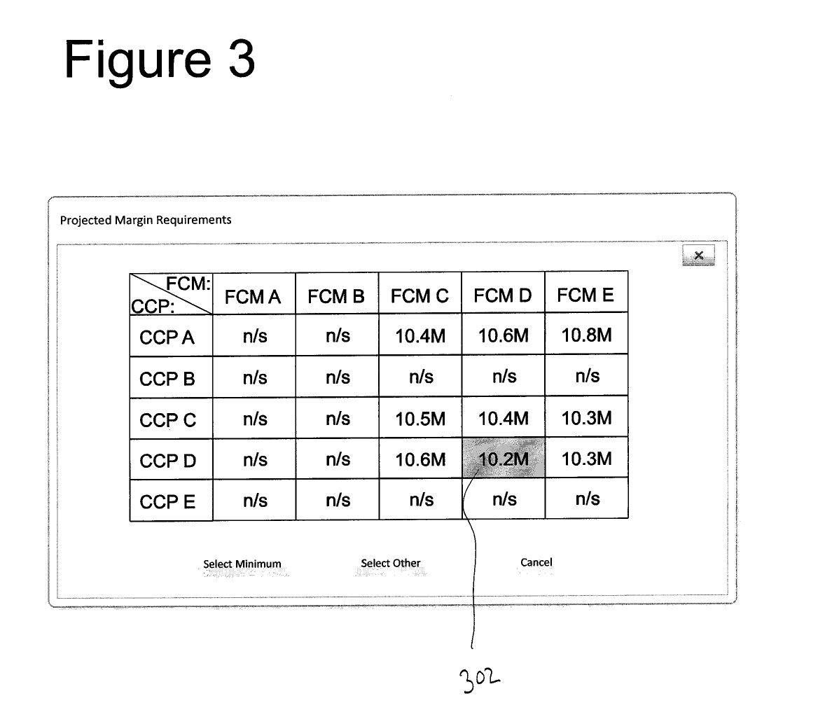

Returning to FIG. 1, the DM platform may then display 106 positions within the user's portfolio. The user may next then identify 108 a proposed swap, i.e., identify the proposed notional amount and tenor of the swap. The DM platform may then estimate 110 margin requirements for the proposed swap for each of the proposed clearance routes (CCP and FCM selections), and present 112 the user with a matrix showing the user the estimated margin costs for each potential clearance route, as shown in FIG. 3, such that the user can propose a swap and clearing route that is in the best interests of the user. The DM platform may highlight 302 the lowest margin requirement to assist the user in identifying a proposed clearance route.

While the above scenario is not likely to be an actual event associated with initiation of an interest rate swap, due to its over-simplification, it is helpful for identifying the basic building blocks associated with the present invention, i.e., the use of margin estimation capabilities to enhance a user's ability to manage a swap transaction.

The margin determination step more properly accommodates additional factors than the simple notional amount and tenor of the transaction. Where the margin determination step is for a position that has been in existence for some period of time, such as where a user desires to consider the impact on margin amounts associated with a separate transaction (such as a termination, compaction, optimization, or other management transaction), the current value of the position may be relevant for any margin determination.

Current value consideration of a position may be undertaken with respect to an existing position through the use of market data which estimates the changed financial values of a pre-existing position through empirical data regarding the present interest rate, as well as predicted interest rates. Simplistically, the value of a present position may be assessed as the present terms of a contra position for the position, i.e., based on the initial notional amount and tenor, the changes in interest rate since inception of the position, current interest rates, and predicted interest rates, an estimate may be arrived at for the contra position, i.e., where the position at issue is a fixed rate position, what variable interest rate position would be considered a proper contra position if a swap was being initiated at the time of the determination. The market data may be used to create and//or estimate an indicative curve which provides the estimated rate of the contra position, i.e., interest rate values for contra positions to existing positions. Thus, one curve may be used to show margins or interest rates for different tenors contra to a fixed rate position, while a complementary curve may be utilized for interest rates for different tenors contra to a variable rate position. The notional amount may be used as a scale factor based on the indicative curves, i.e., while the interest rate varies after inception, the notional amount for comparable positions is directly related to the notional value of the position at the time of determination. As the curve relating fixed and variable interest rates varies over time, the curve is fixed only with respect to a particular point in time.

The values for the indicative curve(s) can be assessed through observation of interest swap trades on a reported market. As present regulations require transparency to the process, swaps are reported as they occur, such that the values that different parties accept for swaps may be used to estimate the present market accepted values for the contra interest rates. By developing and using a live indicative curve from empirical data margin determination may be accomplished on existing positions within a portfolio, as well as for swaps being initiated concurrently with the determination. Indicative curve information may be limited to positions for which sufficient market data is available, and may also include estimations of curve points for other positions for which sufficient market data is not available.

The determination of a margin may also accommodate other factors, such as the particular margin models of different CCP's and FCM's. For example, the margin models may include the type of collateral being provided, such that adjustments to the margin requirement are imposed when the collateral is other than a preferred collateral, such as the legal tender of a particular country. For example, if a preferred collateral is United States dollars, an adjustment may be imposed if the collateral is provided in other currency, such as Japanese yen, Australian dollars, or Great Britain pounds. Other adjustments may be made, for example, for collateral in the form of corporate bonds, money market funds, sovereign debt, U.S. Treasuries, or other corporate securities. What collateral is accepted, and what adjustments are applied to such collateral, may vary from CCP and/or FCM to CCP and/or FCM.

Additionally, and as noted above, other positions held by a party at a CCP or FCM may be used to adjust margin requirements, as the result of offsetting positions within a portfolio. Accordingly, the other positions held by a party may be critical information for the determination engine, as margin factors addressed to the other positions may greatly affect an actual margin requirement for activity within a portfolio. Finally, discount information based on a parties portfolio with a CCP and/or FCM may also be taken into account.

Margin determination models utilized by the DM platform may be either deterministic, i.e., where the platform has access to margin calculations for a CCP or FCM, or may be empirical, such that the DM platform monitors margin activity across a market, and estimates the margin requirements for different CCP's and or FCM's based on reported margin requirements for those parties. Deterministic margin requirements may be either based on internal models running on the DM platform, based on information provided by the CCP's and/or FCM's, or may utilize a call out to individual CCP's and/or FCM's to allow those CCP's and/or FCM's to determine and provide a margin requirement without disclosing their internal margin calculation models.

While the above discusses generation of projected margin requirements associated with CCP's, FCM's may also require margins, or impose other costs, in conjunction with processing transactions associated with a swap position. The margin generation function thus may also generate proposed margins for the FCM's as well as the CCP's, using equivalent deterministic or empirical data, as well as may also include fees and or costs associated with a transaction for presentation to a user.

In a first example of an optimization, User A at Firm A may believe that in order to achieve maximum capital efficiency/minimal margin requirements across clearinghouses that he or she may need to move a position for a swap in which the user is receiving fixed interest (and paying variable interest) on a notional amount of $540 million ($540M) with a five year tenor which was cleared at CCP A to CCP B to reduce margin requirements. User A may believe that moving his or her $540M in trades to be cleared at CCP B because she or he would receive lower margins, offsetting positions or some other margin or collateral benefits from CCP B. To accomplish this, the DM platform may generate and analyze a proposed transaction to allow the move to be implemented.

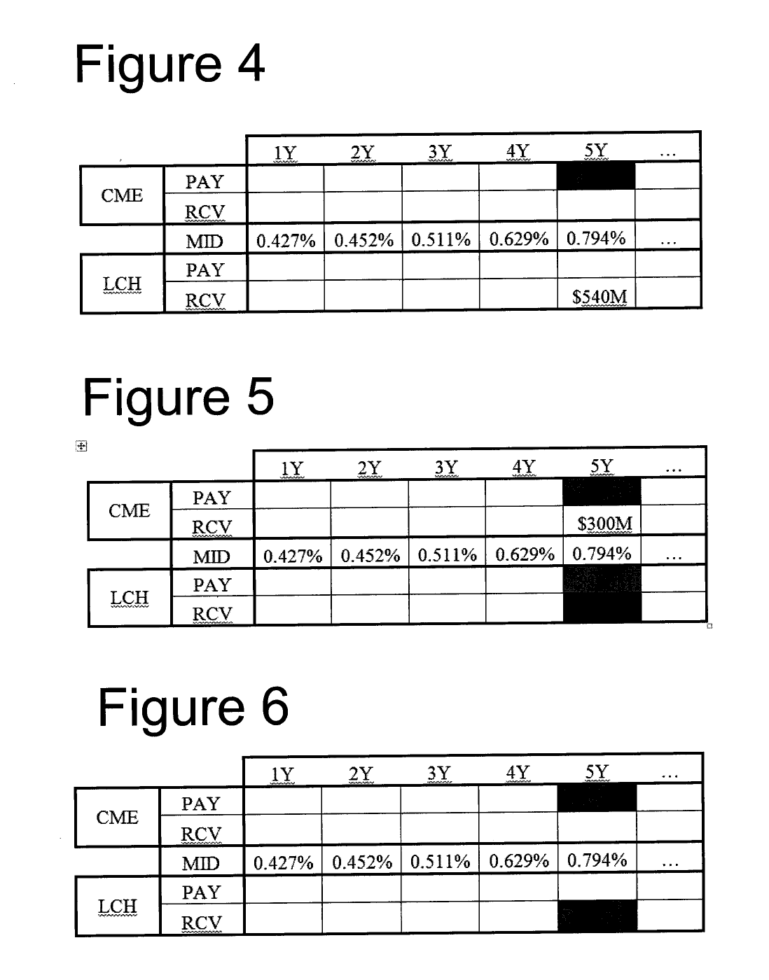

User A may propose an order for paying fixed (and receiving variable interest) through CCP A on $540M on the 5 year tenor (which would offset the $540M he is receiving from CCP A). Such a potential contra-order may be automatically generated for receiving fixed interest on $540M from CCP B as shown in FIG. 4. All the details of the potential contra-order trade may be the same, except the direction of the trade—CCP A will pay fixed and CCP B will be receive fixed. Alternately, where the position has aged since inception, the indicative curve may be utilized to generate a potential contra position based on present period valuation for use in the projected margin generation. Alternately, the potential contra position may use the same details of the trade to be optimized, but may further include payment of a spread in either direction to accommodate valuation changes resultant from the aging of the position in either direction, as indicated by the indicative curve.

Based on the potential contra position, the margin requirements based on the existing position and the potential portfolio position may be estimated or determined. If the proposed activity would result in a reduced margin requirement, User A may indicate a desire to implement the proposed transfer of the position from CCP A to CCP B. To accomplish this, the potential contra order would be converted to an offered contra swap.

To implement the actual activity, a counter party for the proposed activity would need to be identified. Such a counter party could be another trader (or even another user of the DM platform). For example, Trader B from Firm B could desire to receive fixed interest at CCP A for a 5 year tenor on a total notional of $300M. In other words, Trader B is receiving on $300M from CCP B and would rather receive on $300M from CCP A. Trader B seeks to gain an advantage by listing this pair of orders because of their unique margin and collateral benefits at CCP A. To accomplish this, Trader B posts an order to pay fixed at CCP B in the 5 year tenor. A contra-order is automatically generated for Trader B to receive fixed on $300M from CCP A in the 5 year tenor, as shown in FIG. 5. By both parties now holding crossable positions on each CCP, as well as new positions on the desired CCP, the positions can be netted and terminated on the first CCP.

User A and Trader B thus have crossing orders. User A and Trader B may cross for $300M at the mid-rate. This effectively moves $300M of User A's 5 year trades from being cleared at CCP A to being cleared at CCP B and it effectively moves $300M of Trader B's 5 year trades from being cleared at CCP B to being cleared at CCP A. User A is still left with $240M in notional still on the margin optimizer, as shown in FIG. 6.

Thus, User A may have reduced its margin requirement proportionally to the reduced notional amount for which User A is receiving fixed interest on the position at CCP A. The remaining $240M for which User A is receiving fixed interest at CCP A can be further reduced by similar additional activity on the DM platform, such that the entire $540M notional amount for which User A desired to move to CCP B can be moved.

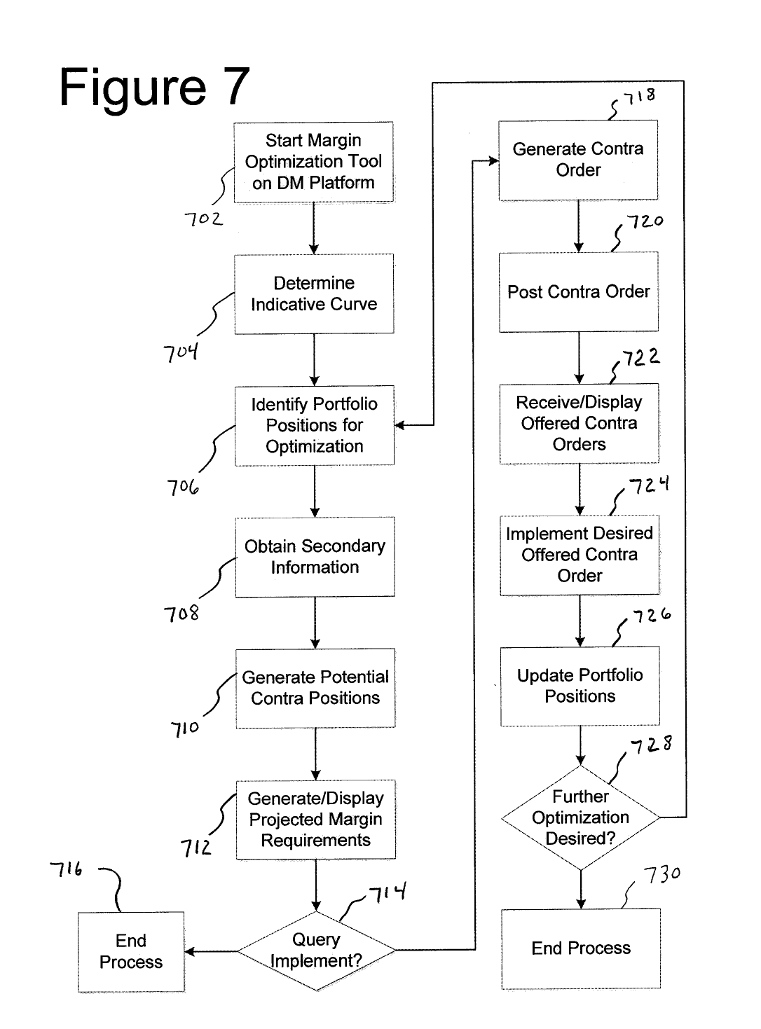

This process may be enacted on the DM platform by User A starting a margin optimization tool, as shown in FIG. 7. For a position which is not newly entered into, the aging of the position may result in different valuations to the position than those which existed when the position was initiated, i.e., for a position in which fixed interest is being received, the margin on the variable (indexed) interest rate may be more or less than when the position was entered into. The margin optimization process thus starts with the DM platform obtaining or determining 704 an indicative curve across relevant products and tenors which may be involved in an optimization transaction. The curve may be a proprietary analytic calculation based on available market data for different increments for possible remaining tenors of positions. It may be provided as a reference point to assist in supporting management activity with respect to an existing portfolio to facilitate evaluation of potential management activities. The curve may be continuously updated through a trading day, or may be updated periodically during a trading day.

Once the indicative curve has been arrived at, the DM platform may identify 706 portfolio positions which a user desires to optimize with respect to margin requirements. The DM platform may obtain 708 secondary information associated with the positions to allow determination of margin requirements, such as the notional amount of the swap, the tenor of the swap, a swap initiation date, and any CCP and/or FCM associated with the position. This information may be utilized by the DM platform to determine or estimate margin requirements associated with any management activity regarding those properties.

In a basic optimization process, in which a user is considering consolidating positions within a particular CCP (for this example CCP A), the DM platform may generate 710 a potential contra order for each identified position. The potential contra order may utilize the indicative curve to determine the potential contra order.

Based on the potential contra order or orders, the DM platform may then generate 712 potential margin requirements for the potential position. The potential margin requirements may accommodate any changes to margin requirements resultant from a reduction in the portfolio held on CCP A, as well as the increase in the portfolio held at CCP B. Thus, the change in margin requirements may be generated as the amount of the reduced margin at CCP A, as well as the increased margin at CCP B, and the aggregate change in margin requirements when the effect at both CCP A and CCP B is considered.

The DM platform may then display the changed margin requirements as a result of the potential transaction, such that the user may receive quantified information regarding the proposed transaction. Where the proposed contra would require a spread in order to accomplish, i.e., a transaction in which the characteristics of the transaction would require payment or receipt of a monetary amount in order to induct the transaction, that spread may additionally be displayed to allow the user to properly evaluate whether the transaction actually makes business sense.

The DM platform may then query 714 the user to determine whether the user desires to implement the transaction. If the user desires that, based on the displayed change in margin requirements, or based on implications of any spread, the he or she does not desire to implement the optimization, the process may end 716.

If the user indicates that he or she desires to implement the optimization, the DM platform may generate 718 an offer for the contra position, and post 720 the contra order for potential opposite parties to offer swaps for the generated contra order. Potential offers associated with contra offers may be received and displayed 722 for the user, and the user may be queried to determine whether the user desires to enter into the transaction associated with the potential offers. If the user does not desire to enter into the offered transaction, the user may so indicate, and consider other offers, or end the process.

If the user desires to accept the offered transaction, the DM platform may implement 724 the transaction, clear the transaction through an indicated clearing route, and adjust 726 the portfolios of the user and the counter party. The crossing orders created by the user can be terminated, as in addition to the new position position receiving fixed interest at CCP B, the user has counter positions for both paying fixed and receiving fixed, in the same tenor and for the same notional amount, at CCP A.

If the transaction did not reduce all of the notional amount of the position on CCP A, the user may be queried 728 to determine if the user desires to continue performing optimizations. If the user indicates that he or she does not desire to transact any further optimizations, the process may end 730. If the user indicates a desire to implement further optimizations, the DM platform may query the user to identify properties for which optimization is being considered, and restart the process.

The use of the margin determination tool additionally provides benefits with respect to other operations, and the benefit may be greater still when margins associated with FCM's are included, as transaction processing costs can further be included within evaluations of proposed transactions. To this end, the implementation of the margin determination function with the management functions identified in Applicant's earlier patent application Ser. No. 13/864,988, filed on Apr. 17, 2013, titled System and Method for Managing Derivative Instruments, the entire disclosure of which is herein incorporated by reference thereto, also provides a beneficial management tool for a user.

The use of the margin determination tool may be applied on a portfolio level to optimize a portfolio. Portfolio optimization allows groups of holdings to be considered for compaction, with the compaction process designed to minimize the margin requirements for the group of holdings. For example, if a user desires to compact a group of positions as between multiple FCM's and/or CCP's, the user could identify those positions for compaction, either by CCP's associated with the positions, or by overall portfolio optimization.

Practically, while optimization considerations may be undertaken for all permutations of combinations of positions, CCP's and FCM's, the additional activity and expense of compactions of significant numbers of positions across CCP's and FCM's precludes the value of such optimizations.

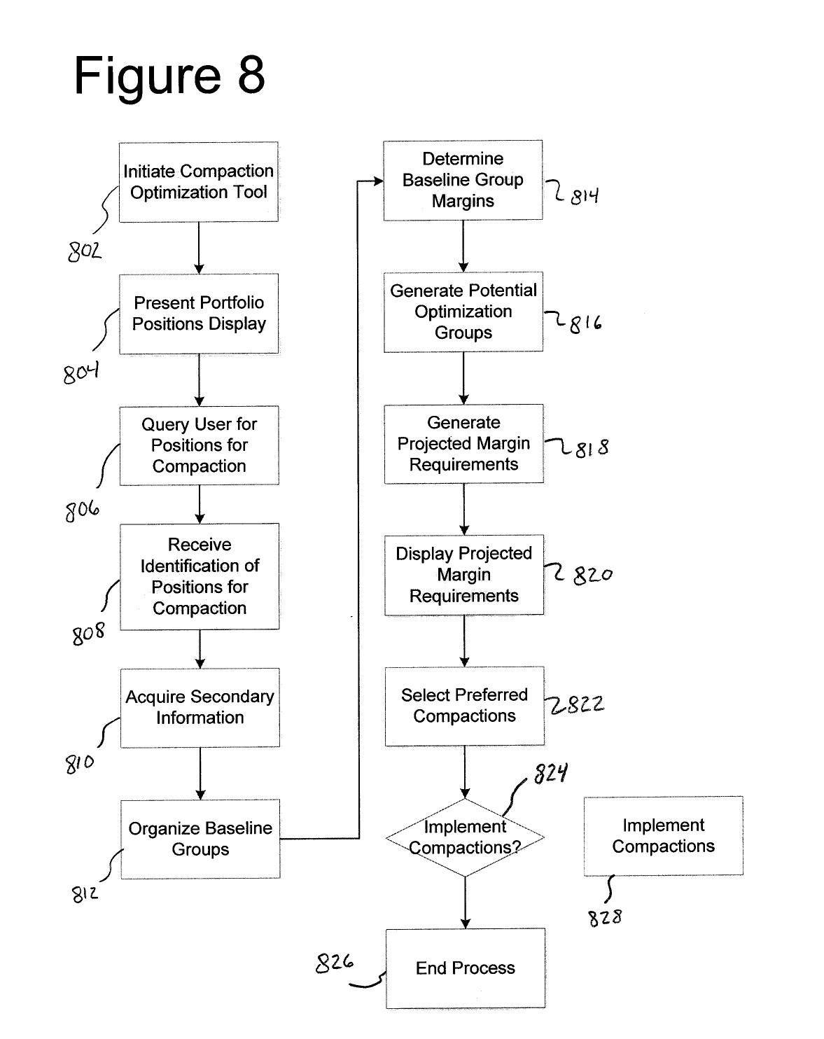

As shown in FIG. 8, and similar to the above, a compaction optimization process, including FCM and CCP margin optimization, may be initiated 802 by a user selecting a compaction optimization tool from the display of the DM platform. The compaction optimization tool may provide 804 the user with a list of all positions within the portfolio, and query 806 the user as to which positions are desired for compaction.

Once the positions to be considered for optimization have been identified 808, the DM platform may acquire 810 the secondary information associated with the positions under consideration. The process of acquiring secondary information may utilize an internally stored database associated with a portfolio, or may rely on an external source for particular information associated with the positions, such as by querying a CCP database, such as the CME Trade Register or the LCH 84C report.

The DM platform may then organize 812 the positions into baseline groups, in which positions are associated with clearing routes (CCP and FCM). Each baseline group will thus have all positions which utilize a particular CCP and FCM. For each baseline group, a margin requirement may be determined 814 using the margin determination capability, with each determined margin requirement being aggregated for a composite number associated with each CCP.

The DM platform may then generate 816 potential optimized groups for each combination of position, CCP, and FCM. The potential compactions may be grouped for the positions under consideration by CCP. Within the positions associated with each CCP, the system may determine FCM's that could be implemented for compacted positions. For example, if ten positions are identified for compaction, distributed between CCP A and CCP B, potential clearing routes for the properties associated with each CCP may be identified. For example, a user may have clearing routes involving CCP A with FCM 1, FCM 2, and FCM 4, while clearing routes for CCP B may be available with FCM 3 and FCM 4.

Based on these possible clearing routes, the DM platform may generate 818 projected margin requirements based on grouping positions within each CCP across the possible FCM's. For the example above, with selected positions 1-5 associated with CCP A, and selected positions 6-15 associated with CCP B, the DM platform may generate proposed compactions for positions 1-5 using clearing routes CCP A-FCM 1, CCP A-FCM 2, and CCP A-FCM 4, as well as proposed compactions for positions 6-15 using clearing routes CCP B-FCM 3 and CCP B-FCM 4. Thus, three potential united optimizations for CCP A would be generated (one for the CCP A positions using a clearing route involving FCM 1, one for the CCP A positions using a clearing route involving FCM 2, etc.) The same margin determinations may be made for properties associated with CCP B and its associated FCM's.

The generated margin requirements for each clearing route may them be displayed 820 for a user, with the generated margin requirements for each clearing route compared against the initial margin requirement associated with the CCP prior to compaction. The user may then select 822 a preferred compaction, whether it is the compaction accomplishing the greatest margin requirement or not. Alternately, the user may compare the projected margin reduction as against costs associated with the potential compaction, to determine whether the compaction makes business sense (i.e., whether the reduction in necessary collateral warrants the costs associate with the compaction.) If the user does not believe that the reduction in margin warrants expenditure of the costs of the compaction, the user may end 826 the process. Alternately, the user may select compaction of positions associated with one CCP, while rejecting compaction of the positions associated with a different CCP.

For positions for which compaction is desired based on the margin reduction values, and for which a clearing route has been selected, the DM platform may implement 828 the compaction by generating offers for the positions indicated for compactions, such that positions in one or more FCM's can be offset against positions acquired through a different FCM, thus allowing the positions to be consolidated within a single clearing route.

The use of the margin requirement determination may be used to assist users when said users are considering contra offers to offerings, i.e., where the counter party dictates the CCP to be used for the swap. For example, where the user offers a position in which the user receives fixed interest for a notional amount for a tenor, a counterparty may offer a contra position using a particular CCP. The user can include the effect on the user's margin requirements for any clearance paths that that user has established for that clearing house, to determine whether the offered trade creates beneficial or adverse considerations with respect to the collateral position of the user.

Similarly, the margin determination function may alternately be used to support back-loading bilateral trades, both with respect to considering the benefit of back-loading a trade, as well as with respect to selecting an optimal clearance route for the transaction. With respect to back-loading, where the counter party does not desire to create mirror trades to the original positions, the indicative curve may be utilized to generate potential contra offers, such that a user could consider the impact of such trades to implement the back-loading before entering into such a transaction. Additionally, the user would be presented with margin requirement determinations such that potential benefits from margin optimization could be concurrently considered along with the potential benefits and costs of the back-load transaction, whether or not the contra position proposed was identical to the original position, or based on a correction to the value of the positions based on the indicative curve.

The present invention may be embodied in other specific forms without departing from the spirit or essential attributes of the invention. Accordingly, reference should be made to the appended claims, rather than the foregoing specification, as indicating the scope of the invention.

What is claimed is:

1) A computer-implemented derivative instrument management system comprising:
a computer platform having: an interfaces that elicits and receives information from users of the system; an interface that allows communications with a clearing house for requesting clearing of management transactions associated with one or more positions associated with a user's portfolio; a database for storing information associated with a user's portfolio; and instructions for implementing a projected margin determination and displaying said projected margin to a user of the derivative investment management system.

2) A computer-implemented derivative instrument management system according to claim 1, wherein said instructions further implement a management transaction which includes communicating a request for a second party to respond to a request to act as a secondary party to a proposed management transaction, receiving from said second party acceptance of said request to act as a secondary party to said management transaction; displaying said acceptance to said user, and communicating an accepted transaction to a clearing house.

3) A computer-implemented derivative instrument management system according to claim 2, wherein said projected margin determination determines a projected margin requirement for a transaction involving a central clearing party.

4) A computer-implemented derivative instrument management system according to claim 3, wherein said projected margin determination uses a deterministic model for projecting margin requirements associated with a transaction.

5) A computer-implemented derivative instrument management system according to claim 2, wherein said margin determination determines a projected margin requirement for a transaction involving a futures commission merchant.

6) A computer-implemented derivative instrument management system according to claim 1, wherein said margin determination determines a projected margin requirement for a transaction involving both a central clearing party and a futures commission merchant.

7) A computer implemented derivative instrument management system according to claim 2, further comprising determination of an indicative curve for generating potential transactions for derivative management operations.

8) A computer implemented derivative instrument management system according to claim 7, wherein said management transaction presents a user with a projected margin requirement for a potential derivative management transaction based on implementation of an indicative curve to estimate the transaction required to implement the derivative management transaction.

9) A computer implemented derivative instrument management system according to claim 8, wherein said derivative management transaction is an optimization of a single position to optimize the margin requirements associated with said position.

10) A computer implemented derivative instrument management system according to claim 9, wherein said derivative management transaction is an optimization of a plurality of positions associated with a plurality of clearing routes to optimize the margin requirements associated with said positions.

11) A computer implemented derivative instrument management process, comprising the steps of:
Receiving at a derivative management platform a request from a user to determine a projected margin requirement associated with a proposed transaction;
Receiving from said user through a computer interface an identification of a position associated with said proposed transaction;
Generating a projected margin requirement for said transaction; and
Displaying said generated projected margin requirement for said transaction to said user.

12) A computer implemented derivative instrument management process according to claim 11, wherein the step of generating a projected margin requirement comprises generating a projected margin requirement utilizing a deterministic model.

13) A computer implemented derivative instrument management process according to claim 11, wherein the step of generating a projected margin requirement comprises generating a projected margin requirement utilizing an empirical model.

14) A computer implemented derivative instrument management process according to claim 11, wherein the step of generating a projected margin requirement comprises generating a projected margin requirement associated with requirements of a central clearing party.

15) A computer implemented derivative instrument management process according to claim 11, wherein the step of generating a projected margin requirement comprises generating a projected margin requirement associated with requirements of a futures commission merchant.

16) A computer implemented derivative instrument management process according to claim 11, wherein the step of generating a projected margin requirement comprises generating a projected margin requirement associated with both the requirements of a central clearing party and the requirements of a futures commission merchant.

17) A computer implemented derivative instrument management process according to claim 11, further comprising the step of determining an indicative curve for generating potential contra positions to a potential management transaction.

18) A computer implemented derivative instrument management process according to claim 17, further comprising the step of presenting a user with a projected margin requirement for a potential derivative management transaction based on implementation of an indicative curve to estimate the transaction required to implement the derivative management transaction.

19) A computer implemented derivative instrument management process according to claim 18, wherein said potential derivative management transaction is an optimization of a single position to optimize the margin requirements associated with said position.

20) A computer implemented derivative instrument management process according to claim 19, wherein said derivative management transaction is an optimization of a plurality of positions associated with a plurality of clearing routes to optimize the margin requirements associated with said positions.
